(19) United States
(12) Patent Application Publication
(10) Pub. No.: US 2024/0070770 A1
(43) Pub. Date: Feb. 29, 2024

(54) System and Method for Real-Time Minting and Enrichment of Sports Data

(71) Applicant: STATS LLC, Chicago, IL (US)

(72) Inventors: Christian Marko, Graz (AT); Matjaz Ales, Maribor (SI); Lukas Marek, Prague (CZ); Shaun McMurray, Graz (AT); Vadim Torosyan, Prague (CZ); Markus Klausmann, Munich (DE)

(73) Assignee: STATS LLC, Chicago, IL (US)

(21) Appl. No.: 18/452,954

(22) Filed: Aug. 21, 2023

Related U.S. Application Data
(60) Provisional application No. 63/373,509, filed on Aug. 25, 2022.

(51) Int. Cl. G06Q 30/08; G06Q 20/36

(52) U.S. Cl. CPC G06Q 30/08; G06Q 20/36; G06Q 2220/00

(57) ABSTRACT

A computing system generates a portal to be accessed by a plurality of users. The portal includes a representation of a game and a plurality of gamification elements. The computing system receives data related to the game represented in the portal. The computing system monitors the data to detect an event to occur within the game. Based on the monitoring, the computing system determines that the event has occurred within the game. Based on the determining, the computing system generates a graphic associated with the event. The computing system generates a non-fungible token corresponding to the event. The non-fungible token is linked to the graphic. The computing system broadcasts the non-fungible token to a blockchain.

### CROSS-REFERENCE TO RELATED APPLICATIONS

This application claims priority to U.S. Provisional Application Ser. No. 63/373,509, filed Aug. 25, 2022, which is hereby incorporated by reference in its entirety.

### FIELD OF THE DISCLOSURE

The present disclosure generally relates to a system and method for real-time minting and enrichment of sports data.

### BACKGROUND

With the proliferation of data, sports teams, commentators, and fans alike are more interested in identifying and classifying events that occur throughout a game or across a season. As companies develop models configured to generate various predictions and metrics, surfacing these predictions and metrics to the user becomes increasingly important.

### SUMMARY

In some embodiments, a method is disclosed herein. A computing system generates a portal to be accessed by a plurality of users. The portal includes a representation of a game and a plurality of gamification elements. The computing system receives data related to the game represented in the portal. The data includes at least one of tracking data or event data. The computing system monitors the data to detect an event to occur within the game. Based on the monitoring, the computing system determines that the event has occurred within the game. Based on the determining, the computing system generates a graphic associated with the event. The graphic includes insights related to the event. The computing system generates a non-fungible token corresponding to the event. The non-fungible token is linked to the graphic. The computing system broadcasts the non-fungible token to a blockchain.

In some embodiments, a non-transitory computer readable medium. The non-transitory computer readable medium includes one or more sequences of instructions, which, when executed by one or more processors, causes a computing system to perform operations. The operations include generating, by the computing system, a portal to be accessed by a plurality of users. The portal includes a representation of a game and a plurality of gamification elements. The operations further include receiving, by the computing system, data related to the game represented in the portal. The data includes at least one of tracking data or event data. The operations further include monitoring, by the computing system, the data to detect an event to occur within the game. The operations further include, based on the monitoring, determining, by the computing system, that the event has occurred within the game. The operations further include, based on the determining, generating, by the computing system, a graphic associated with the event. The graphic includes insights related to the event. The operations further include generating, by the computing system, a non-fungible token corresponding to the event. The non-fungible token is linked to the graphic. The operations further include broadcasting, by the computing system, the non-fungible token to a blockchain.

In some embodiments, a system is disclosed herein. The system includes a processor and a memory. The memory has programming instructions stored thereon, which, when executed by the processor, causes the system to perform operations. The operations include generating a portal to be accessed by a plurality of users. The portal includes a representation of a game and a plurality of gamification elements. The operations further include receiving data related to the game represented in the portal. The data includes at least one of tracking data or event data. The operations further include monitoring the data to detect an event to occur within the game. The operations further include, based on the monitoring, determining that the event has occurred within the game. The operations further include, based on the determining, generating a graphic associated with the event. The graphic includes insights related to the event. The operations further include generating a non-fungible token corresponding to the event. The non-fungible token is linked to the graphic. The operations further include broadcasting the non-fungible token to a blockchain.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating organization computing system 104, according to example embodiments

FIG. 3 illustrates an exemplary graphical user interface, according to example embodiments.

FIG. 4 illustrates an exemplary graphical user interface, according to example embodiments.

FIG. 5 is a flow diagram illustrating a method of generating a non-fungible token corresponding to a game event, according to example embodiments.

FIG. 6A is a block diagram illustrating a computing device, according to example embodiments.

FIG. 6B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Digital business models are more in focus than ever in the sports world. In order to remain competitive and become less dependent on sporting success, sports rights holders may seek to generate new sources of income. All sports rights holders are facing two main challenges: economic losses and alienations of fans. A much more targeted and sustainable measure for sports rights holders may be to invest in new, digital business models in order to respond to the needs of the fan base.

The primary goal of sports rights holders should be a satisfied and engaged fan, which is ultimately the core of all further value creation of a sports organization. Blockchain technology may help to maintain contact with the digitally savvy young target group and, ideally, retain them through fan engagement measures. However, professional sports organizations are still a long way from widespread use of the technology.

One or more techniques described herein provide a means to maintain contact with sports fans to drive fan engagement. For example, one or more techniques described herein provide a system that is able to connect sports with Web3 technology. In some embodiments, key moments in a sports event can by directly transformed into a minted non-fungible token. To further drive user engagement, the present system may incorporate gamification aspects into the non-fungible token minting and assignment process. In this manner, users can interact with the system during live events to participate in the minting process. By combining the large interest with sports with the excitement of gamification, the present system provides sports organizations with technology to further drive fan engagement with the product.

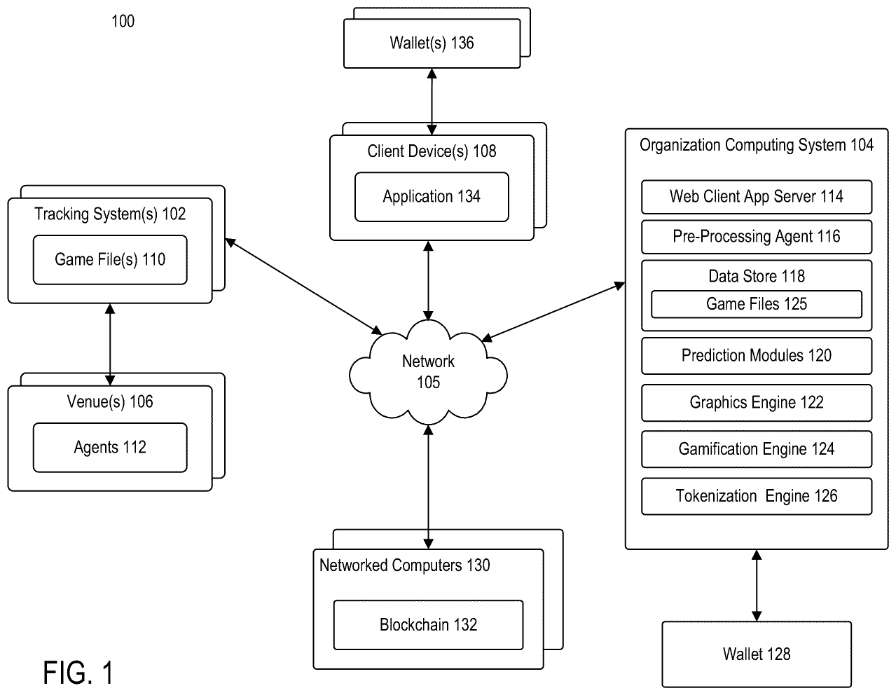

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.). In some embodiments, tracking system 102 may be used for a broadcast feed of a given match. In such embodiments, each frame of the broadcast feed may be stored in a game file 110.

In some embodiments, game file 110 may further be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, prediction modules 120, graphics engine 122, a gamification engine 124, and a tokenization engine 126.

Each of pre-processing agent 116, prediction modules 120, graphics engine 122, gamification engine 124, and tokenization engine 126 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 125. Each game file 125 may include video data of a given match. For example, the video data may correspond to a plurality of video frames captured by tracking system 102. In some embodiments, the video data may correspond to broadcast data of a given match, in which case, the video data may correspond to a plurality of video frames of the broadcast feed of a given match.

Pre-processing agent 116 may be configured to process data retrieved from data store 118. For example, pre-processing agent 116 may be configured to generate game files 125 stored in data store 118. For example, pre-processing agent 116 may be configured to generate a game file 125 based on data captured by tracking system 102. In some embodiments, pre-processing agent 116 may further be configured to store tracking data associated with each game in a respective game file 125. Tracking data may refer to the (x, y) coordinates of all players and balls on the playing surface during the game. In some embodiments, pre-processing agent 116 may receive tracking data directly from tracking system 102. In some embodiments, pre-processing agent 116 may derive tracking data from the broadcast feed of the game.

Prediction modules 120 may be representative of one or more prediction models associated with STATS Perform, located in Chicago, Illinois. For example, prediction modules 120 may be representative of one or more prediction models, such as, but not limited to, scoring prediction models, models that automatically detect events (e.g., in basketball—ball-screens, isolations, off-ball-screens, soccer: counter-attacks, set-plays), expected metrics (e.g., expected goals, expected possession and expected pass completion), player and team power rankings, player and team player prop predictions during the match or season simulation (both in terms of final table position as well as final player and team statistics at the end of the season), and the like.

Graphics engine 122 may be configured to generate one or more graphics that may include sports data and insights generated by prediction modules 120. For example, graphics engine 122 may generate high-resolution player and team images, videos, GIFs, and the like that may be matched with real-time or near real-time sports data and insights. Graphics engine 122 may, generally, be representative of Opta Graphics, an intuitive multi-media graphics tool, commercially available from STATS Perform. In some embodiments, graphics engine 122 may generate a graphic corresponding to certain events within a live game. Exemplary events may include, but are not limited to, scoring attempts, passes, blocks, goals, and the like.

Gamification engine 124 may be configured to generate one or more gamification elements for end users. For example, gamification engine 124 may be configured to generate a portal or webpage through which a user or group of users can view a game in real-time or near real-time. In some embodiments, gamification engine 124 may generate one or more gamification elements to be included in the portal or webpage.

Gamification engine 124 may be configured to facilitate a gamification approach to fan engagement. In operation, gamification engine 124 may generate one or more graphical elements that may allow users to bid on a potential non-fungible token corresponding to a given graphic generated by graphics engine 122. For example, leading up to an event, gamification engine 124 may be configured to prompt users to bid on a non-fungible token that is to be generated for the next event in the game. Users can, for example, watch the game in the portal or webpage and can submit bids for a non-fungible token. The non-fungible token may not yet be generated. Instead, users may simply bid on a potential non-fungible token that may be generated to correspond to an upcoming event in a game. Using a specific example, when a game starts, users may be provided with the opportunity to place bids on a potential non-fungible token. When an event in the game occurs, graphics engine 122 may be configured to generate a graphic corresponding to the event. As provided above, the graphic may include insights or data corresponding to the event. Gamification engine 124 may reward the highest bidder with ownership rights to a non-fungible token corresponding to the generated graphic.

As shown, computing environment 100 includes networked computers 130. Networked computers 130 may be configured to host blockchain 132. In some embodiments, blockchain 132 may be a public blockchain. In some embodiments, blockchain 132 may be a private blockchain, such as, for example, a private blockchain associated with organization computing system 104. Generally, blockchain 132 may be representative of any blockchain configured to support non-fungible tokens. For example, blockchain 132 may be a public or private blockchain based on the Ethereum platform.

Referring back to organization computing system 104, when a graphic corresponding to an event is generated by graphics engine 122, tokenization engine 126 may be configured to perform a “minting” process to generate a non-fungible token corresponding to the generated graphic and broadcast the non-fungible token to blockchain 136. Tokenization engine 126 may be configured to tokenize the graphic generated by graphics engine 122. For example, tokenization engine 126 may be configured to generate a smart contract based on the generated graphic content. In some embodiments, the smart contract may be representative of an ERC721 contract. In some embodiments, the smart contract may be representative of an ERC1155 contract.

In some embodiments, the graphic corresponding to the non-fungible token may be stored off-chain (e.g., in a local storage location or an external storage location (e.g., InterPlanetary File System (IPFS))), and a uniform resource identifier (URI) corresponding to the storage location of the graphic may be included in the metadata of the non-fungible token. In some embodiments, the graphic may be stored on-chain by hashing the graphic and including the hashed graphic in the metadata of the non-fungible token.

Once the non-fungible token is generated, tokenization engine 126 may broadcast or write the token to blockchain 132.

In some embodiments, tokenization engine 126 may temporarily store the non-fungible token in a wallet associated with organization computing system 104, i.e., wallet 128. Wallet 128 may be configured to store fungible tokens (e.g., cryptocurrency) and non-fungible tokens associated with organization computing system 104 in an encrypted manner. In some embodiments, wallet 128 may be representative of a hot wallet, which is a cryptographic wallet connected to a network, such as network 105. In some embodiments, wallet 128 may be representative of a cold wallet, which is not connected to a network.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 134. Application 134 may be representative of a web browser that allows access to a website or a stand-alone application. Client device 108 may access application 134 to access one or more functionalities of organization computing system 104. Client device 108 may communicate over network 105 to request a webpage, for example, from web client application server 114 of organization computing system 104. For example, client device 108 may be configured to execute application 134 to watch a live sporting event. Via a sporting even portal or website, the user of client device 108 may participate in a bidding process, in which the user bids on the opportunity to win a non-fungible token corresponding to an event that has yet to occur. The content that is displayed to client device 108 may be transmitted from web client application server 114 to client device 108, and subsequently processed by application 134 for display through a graphical user interface (GUI) of client device 108.

As shown, client device 108 may include a wallet 136. Wallet 136 may be configured to store a user's fungible tokens and non-fungible tokens in an encrypted manner. In some embodiments, wallet 136 may be representative of a hot wallet, which is a cryptographic wallet connected to a network, such as network 105. In some embodiments, wallet 136 may be representative of a cold wallet, which is not connected to a network.

In some embodiments, if the user successfully bid on non-fungible token, tokenization engine 126 may transfer the non-fungible token from wallet 128 to wallet 136. In some embodiments, transferring the non-fungible token from wallet 128 to wallet 136 may involve tokenization engine 126 writing or broadcasting the transaction to blockchain 132. Once the non-fungible token is in the user's possession, the user is able to utilize the non-fungible token to their liking. For example, the user could offer the non-fungible token for sale via one or more third party marketplaces, such as, but not limited to, OpenSea.

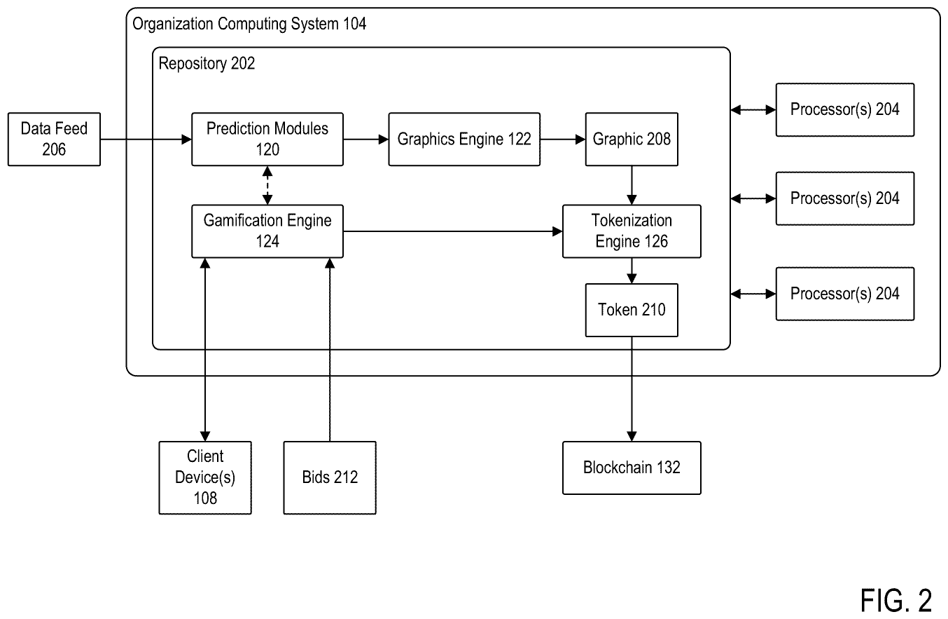

FIG. 2 is a block diagram illustrating organization computing system 104, according to example embodiments. As shown, organization computing system 104 includes repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site.

Repository 202 may include prediction modules 120, graphics engine 122, tokenization engine 126, and gamification engine 124. As shown, organization computing system 104 may be in communication with data feed 206. In some embodiments, data feed 206 may correspond to a data feed provided by tracking system 102. In some embodiments, data feed 206 may be in the form of a tracking data feed (e.g., x,y coordinates of each player). In some embodiments, data feed 206 may be in the form of an event data feed (e.g., OPTA data feed). In some embodiments, data feed 206 may be in the form of a broadcast data feed.

Prediction modules 120 may receive information from data feed 206. Although not shown, as discussed above, data feed 206 may undergo one or more pre-processing operations before being input to prediction modules 120. Based on information in data feed 206, prediction modules 120 may automatically detect events (e.g., in basketball—ball-screens, isolations, off-ball-screens, soccer: counter-attacks, set-plays), generate expected metrics (e.g., expected goals, expected possession and expected pass completion), player and team power rankings, player and team player prop predictions during the match or season simulation (both in terms of final table position as well as final player and team statistics at the end of the season), and the like.

Responsive to an event occurring, graphics engine 122 may generate a graphic 208 corresponding to the event. In some embodiments, graphics engine 122 may generate graphic 208 from a template based on the detected event. In some embodiments, graphic 208 may include data associated with the event. In some embodiments, graphic 208 may include data describing the event. For example, for a graphic corresponding to a goal, the graphic may include the team that scored the goal, the player that scored the goal, the minute the goal was scored, the opponent against which the goal was scored, and the current score. In some embodiments, the graphic may include insights of metrics generated by prediction modules 120. For example, for a tennis serve, the graphic may indicate that the serve was the fastest serve in history.

As shown, while prediction modules 120 are generating prediction, gamification engine 124 may generate a portal or webpage accessible by client devices 108. In some embodiments, gamification engine 124 may include a visualization of the current game in progress. In some embodiments, the visualization can be the actual broadcast video of the current game. In some embodiments, the visualization can be a representation of the current game (e.g., a widget in which icons track movement of players on a field). Based on the progress for the game, users can submit bids 212. Bids 212 may correspond to bids for an upcoming event. For example, as the event initializes, users may submit bids to win a non-fungible token corresponding to the next detected event. In some embodiments, users may be guided by real-time or near real-time predictions generated by prediction modules 120. For example, given the current state of the game (e.g., score, player location, ball location, time left, etc.), prediction modules 120 may predict that a shot or a goal is likely to occur. Gamification engine 124 may identify the winning bidder based on the highest received bid at the time of the event occurring.

Tokenization engine 126 may be configured to generate a token 210 corresponding to graphic 208. For example, tokenization engine 126 may generate a smart contract corresponding to graphic 208. In some embodiments, the smart contract may be representative of an ERC721 contract. In some embodiments, the smart contract may be representative of an ERC1155 contract. Tokenization engine 126 may then broadcast token 210 to blockchain 130.

In some embodiments, such as that described above, tokenization engine 126 may further transfer token 210 to a wallet 136 associated with the winning bidder.

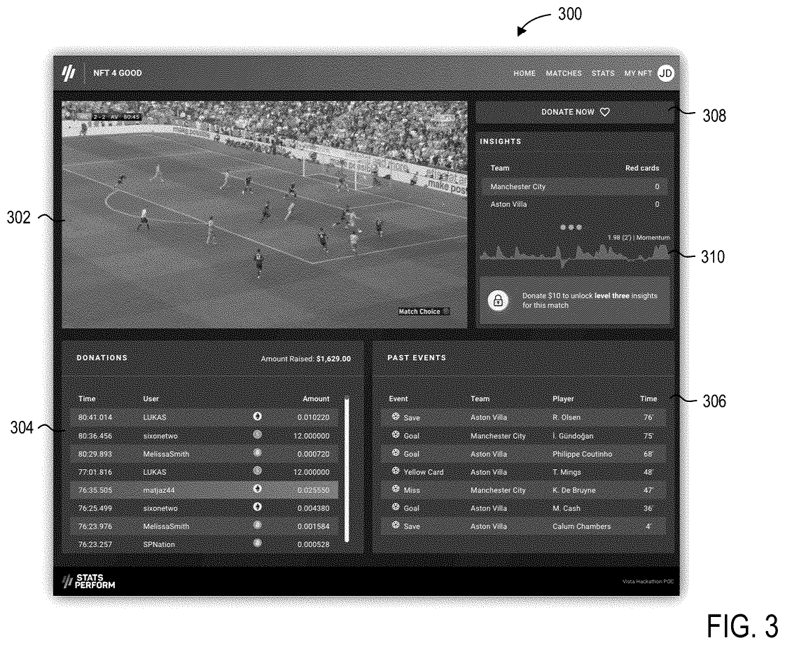

FIG. 3 illustrates an exemplary graphical user interface (GUI) 300, according to example embodiments. GUI 300 may correspond to a portal or webpage generated by gamification engine 124.

As shown, GUI 300 may include graphical element 302, graphical element 304, graphical element 306, and graphical element 308. Graphical element 302 may correspond to a visualization of a live game or event. In some embodiments, such as that shown, the visualization can be the actual broadcast video of the current game. In some embodiments, the visualization can be a representation of the current game (e.g., a widget in which icons track movement of players on a field).

Graphical element 308 may correspond to a bid submission button or element. Via graphical element 308, a user can submit a bid for a non-fungible token. In some embodiments, the bids may correspond to donations to a given charity. For example, instead of a central entity associated with organization computing system 104 receiving the financial benefit of the bids, the bids can be aggregated and provided to a charitable entity. In some embodiments, graphical element 308 may allow the users to donate via one or more financial instructions, such as, but not limited to, credit cards, debit cards, payment providers, cryptocurrencies, and the like.

Graphical element 304 may correspond to a bid leaderboard. When a key event in a match occurs (e.g., goal, save etc.), the person who made the most recent donation is rewarded with a non-fungible token representing this same event. To increase the excitement of watching sport events live, graphical element 304 includes a leaderboard to show the current leader in the donation race. In some embodiments, the winner may be the person who made a donation or bid closest to the event occurring. In some embodiments, the winner may be the person who bid the most amount of money. In some embodiments, the leader may be randomly selected from a group or pool of people that donated or bid a threshold amount.

Graphical element 306 may correspond to past events within the match. For example, graphical element 306 may list all the previous events that occurred in the game. In some embodiments, each event in graphical element 306 may have a corresponding non-fungible token generated by tokenization engine 126.

In some embodiments, GUI 300 may further include graphical element 310. Graphical element 310 may be provide to those users that have donated or submitted a payment above a certain threshold. Graphical element 310 may correspond to real-time or near real-time artificial intelligence insights generated by prediction modules 120. As shown, graphical element 310 can display a momentum graphic that visually depicts which team has the current momentum. More generally, such insights included in GUI 300 may generated from any sport, such as, but not limited to, soccer, basketball, rugby, tennis, hockey, football, baseball, cricket, and the like.

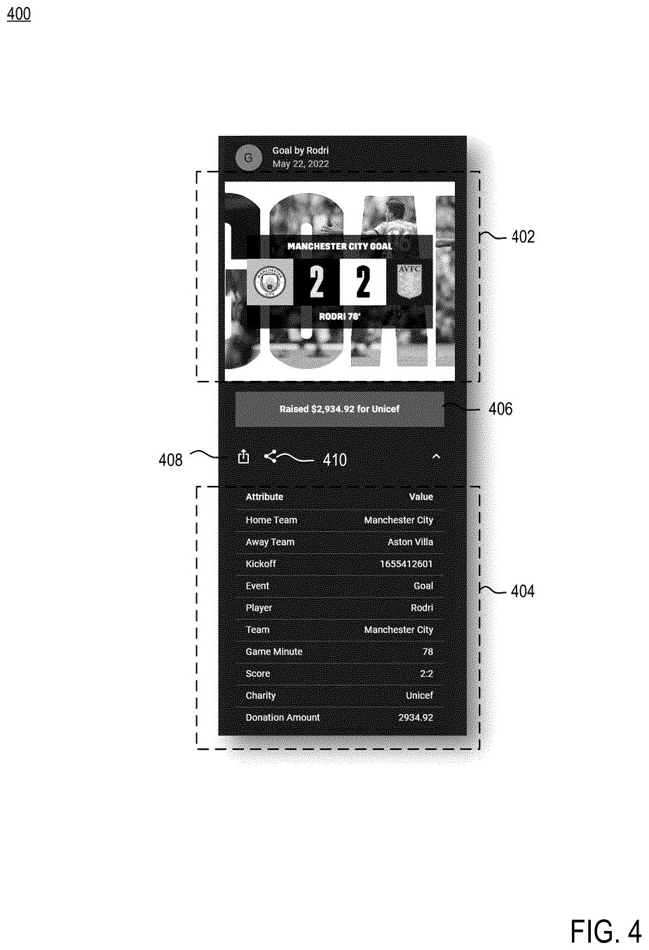

FIG. 4 illustrates an exemplary graphical user interface (GUI) 400, according to example embodiments. GUI 400 may correspond to a graphic and associated metadata of a non-fungible token generated by tokenization engine 126.

As shown, GUI 400 may include graphic 402. Graphic 402 may correspond to a graphic generated by graphics engine 122. Graphic 402 may visually depict or capture an event that occurred within the game. As shown, graphic 402 may correspond to goal scored by Rodri in the 78^{th} minute of the game between Manchester City and Aston Villa F.C.

In some embodiments, GUI 400 may further include traits 404 corresponding to the non-fungible token. As shown, traits 404 may include attributes of the non-fungible token. For example, as shown, traits 404 may include attributes that include, but is not limited to, home team, away team, kickoff, event, player, team, game minute, score, charity, and donation amount.

In some embodiments, GUI 400 may further include graphical elements 406-410. Graphical element 406 may correspond to an indication of the amount of money raised for a target charity during the bidding process. In this example, the target event raised $2,934.92 for Unicef. Graphical element 408 may correspond to a withdraw icon. Via graphical element 408, a user may withdraw their non-fungible token at any time. In some embodiments, withdrawing the non-fungible token may mean organization computing system 104 transferring the non-fungible token from wallet 128 to wallet 136 (e.g., from a wallet associated with organization computing system 104 to a wallet of the user). Graphical element 410 may correspond to a linking button. Via graphical element 410, a user can share their non-fungible token with external parties or platforms.

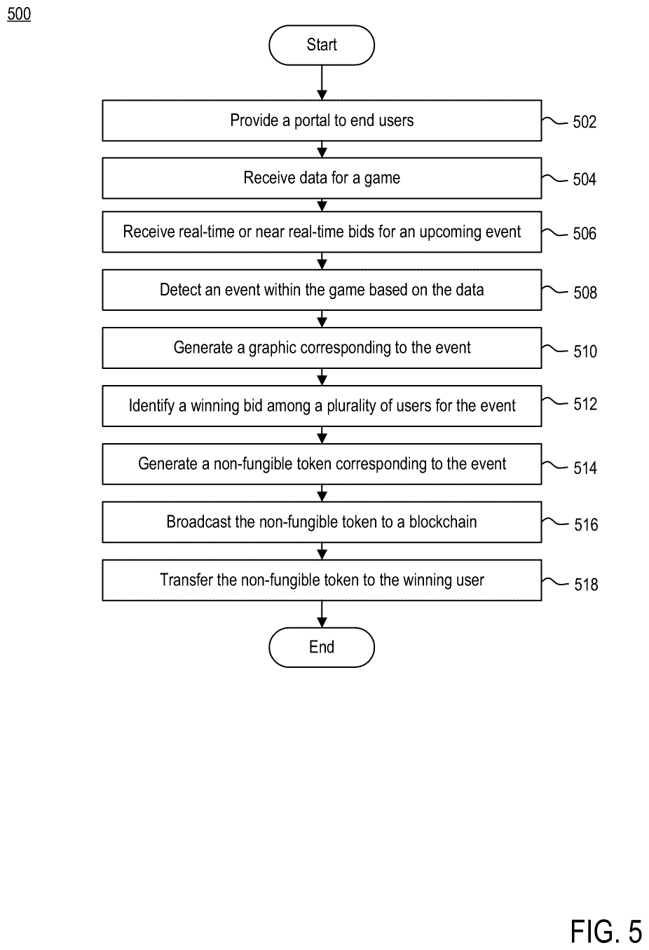

FIG. 5 is a flow diagram illustrating a method 500 of generating a non-fungible token corresponding to a game event, according to example embodiments. Method 500 may begin at step 502.

At step 502, organization computing system 104 may provide a portal to end users. For example, gamification engine 124 may generate a portal or webpage through which a user or group of users can view a game in real-time or near real-time. In some embodiments, gamification engine 124 may include a visualization of the current game in progress. In some embodiments, the visualization can be the actual broadcast video of the current game. In some embodiments, the visualization can be a representation of the current game (e.g., a widget in which icons track movement of players on a field). In some embodiments, gamification engine 124 may generate one or more gamification elements to be included in the portal or webpage. Such gamification elements may allow end users to interact with the game in progress by bidding on the opportunity to win a non-fungible token associated with a next event to occur.

At step 504, organization computing system 104 may receive data for a game. In some embodiments, the data may include tracking data for the game. In some embodiments, tracking data may be received from tracking system 102. In some embodiments, tracking data may be derived from a broadcast video stream of the game. In some embodiments, the data may include event data for the game. In some embodiments, prediction modules 120 and/or pre-processing agent 116 may generate or derive the event data from the tracking data and/or broadcast data. In some embodiments, event data may be received from tracking system 102.

At step 506, organization computing system 104 may receive real-time or near real-time bids for an upcoming event. For example, via the portal or webpage, users can submit bids to win a non-fungible token corresponding to the next upcoming event. In some embodiments, users may be guided by real-time or near real-time predictions generated by prediction modules 120. For example, given the current state of the game (e.g., score, player location, ball location, time left, etc.), prediction modules 120 may predict that a shot or a goal is likely to occur.

At step 508, organization computing system 104 may detect an event within the game based on the data. In some embodiments, pre-processing agent 116 may detect an event within the data by analyzing tracking data and/or event data. In some embodiments, prediction modules 120 may detect an event within the data utilizing one or more machine learning algorithms. An event may refer to a goal, a pass, a record breaking event, and the like.

At step 510, organization computing system 104 may generate a graphic corresponding to the event. For example, responsive to detecting an event within the game, graphics engine 122 may be configured to generate one or more graphics that may include sports data and insights, generated by prediction modules 120, that may be related to the event. For example, graphics engine 122 may generate a high-resolution images, videos, GIFs, or the like that may be matched with real-time or near real-time sports data and insights related to the event. Graphics engine 122 may, generally, be representative of Opta Graphics, an intuitive multi-media graphics tool, commercially available from STATS Perform.

At step 512, organization computing system 104 may identify a winning bid among a plurality of users for the event. For example, based on one or more of a recency of the user's bid and an amount of the user's bid, gamification engine 124 may select a winner of the non-fungible token.

At step 514, organization computing system 104 may generate a non-fungible token corresponding to the event. For example, tokenization engine 126 may perform a minting process to generate a non-fungible token corresponding to the generated graphic. Tokenization engine 126 may tokenize the graphic generated by graphics engine 122. For example, tokenization engine 126 may generate a smart contract based on the generated graphic content corresponding to the event. In some embodiments, the smart contract may be representative of an ERC721 contract. In some embodiments, the smart contract may be representative of an ERC1155 contract.

At step 516, organization computing system 104 may broadcast the non-fungible token to a blockchain. For example, tokenization engine 126 may broadcast or write the non-fungible token to blockchain 132.

In some embodiments, method 500 may further include step 518. At step 518, organization computing system 104 may transfer the non-fungible token to a wallet associated with the highest bidder. For example, in some embodiments, initially, tokenization engine 126 may store the non-fungible token in wallet 128 that is associated with organization computing system 104. Tokenization engine 126 may transfer the non-fungible token from wallet 128 to wallet 136 associated with the highest bidder. In some embodiments, such transfer of the non-fungible token may result in tokenization engine 126 memorializing or writing the transaction to blockchain 132.

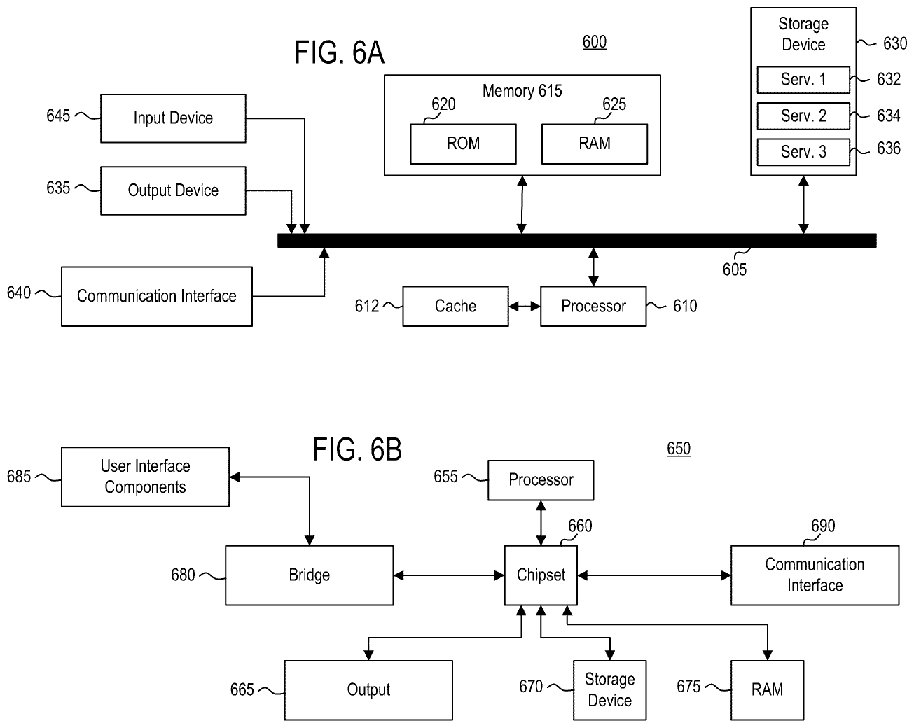

FIG. 6A illustrates an architecture of computing system 600, according to example embodiments. System 600 may be representative of at least a portion of organization computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 (e.g., display) may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635, and so forth, to carry out the function.

FIG. 6B illustrates a computer system 650 having a chipset architecture that may represent at least a portion of organization computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid-state media, for example. Chipset 660 may also read data from and write data to RAM 675. A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or RAM 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method comprising:
generating, by a computing system, a portal to be accessed by a plurality of users, the portal comprising a representation of a game and a plurality of gamification elements;
receiving, by the computing system, data related to the game represented in the portal, the data comprising at least one of tracking data or event data;
monitoring, by the computing system, the data to detect an event to occur within the game;
based on the monitoring, determining, by the computing system, that the event has occurred within the game;
based on the determining, generating, by the computing system, a graphic associated with the event, wherein the graphic comprises insights related to the event;
generating, by the computing system, a non-fungible token corresponding to the event, wherein the non-fungible token is linked to the graphic; and
broadcasting, by the computing system, the non-fungible token to a blockchain.

2. The method of claim 1, further comprising:
receiving, by the computing system, real-time or near real-time bids for the non-fungible token to be generated for the event to be detected in the game; and
identifying, by the computing system, a winning user of the plurality of users based on the real-time or near real-time bids.

3. The method of claim 2, further comprising:
storing, by the computing system, the non-fungible token in a wallet associated with the computing system.

4. The method of claim 3, further comprising:
transferring, by the computing system, the non-fungible token from the wallet associated with the computing system to a second wallet associated with the winning user.

5. The method of claim 4, further comprising:
writing, by the computing system, a transfer of the non-fungible token from the wallet associated with the computing system to the second wallet associated with the winning user to the blockchain.

6. The method of claim 1, further comprising:
generating, by the computing system, an artificial intelligence driven prediction based on the data.

7. The method of claim 6, further comprising:
causing, by the computing system, presentation of the artificial intelligence driven prediction in the portal.

8. A non-transitory computer readable medium comprising one or more sequences of instructions, which, when executed by one or more processors, causes a computing system to perform operations comprising:
generating, by the computing system, a portal to be accessed by a plurality of users, the portal comprising a representation of a game and a plurality of gamification elements;
receiving, by the computing system, data related to the game represented in the portal, the data comprising at least one of tracking data or event data;
monitoring, by the computing system, the data to detect an event to occur within the game;
based on the monitoring, determining, by the computing system, that the event has occurred within the game;
based on the determining, generating, by the computing system, a graphic associated with the event, wherein the graphic comprises insights related to the event;
generating, by the computing system, a non-fungible token corresponding to the event, wherein the non-fungible token is linked to the graphic; and
broadcasting, by the computing system, the non-fungible token to a blockchain.

9. The non-transitory computer readable medium of claim 8, further comprising:
receiving, by the computing system, real-time or near real-time bids for the non-fungible token to be generated for the event to be detected in the game; and
identifying, by the computing system, a winning user of the plurality of users based on the real-time or near real-time bids.

10. The non-transitory computer readable medium of claim 9, further comprising:
storing, by the computing system, the non-fungible token in a wallet associated with the computing system.

11. The non-transitory computer readable medium of claim 10, further comprising:
transferring, by the computing system, the non-fungible token from the wallet associated with the computing system to a second wallet associated with the winning user.

12. The non-transitory computer readable medium of claim 11, further comprising:
writing, by the computing system, a transfer of the non-fungible token from the wallet associated with the computing system to the second wallet associated with the winning user to the blockchain.

13. The non-transitory computer readable medium of claim 8, further comprising:
generating, by the computing system, an artificial intelligence driven prediction based on the data.

14. The non-transitory computer readable medium of claim 13, further comprising:
causing, by the computing system, presentation of the artificial intelligence driven prediction in the portal.

15. A system comprising:
a processor; and
a memory having programming instructions stored thereon, which, when executed by the processor, causes the system to perform operations comprising:
generating a portal to be accessed by a plurality of users, the portal comprising a representation of a game and a plurality of gamification elements;
receiving data related to the game represented in the portal, the data comprising at least one of tracking data or event data;
monitoring the data to detect an event to occur within the game;
based on the monitoring, determining that the event has occurred within the game;
based on the determining, generating a graphic associated with the event, wherein the graphic comprises insights related to the event;
generating a non-fungible token corresponding to the event, wherein the non-fungible token is linked to the graphic; and
broadcasting the non-fungible token to a blockchain.

16. The system of claim 15, wherein the operations further comprise:
receiving real-time or near real-time bids for the non-fungible token to be generated for the event to be detected in the game; and
identifying a winning user of the plurality of users based on the real-time or near real-time bids.

17. The system of claim 16, wherein the operations further comprise:
storing the non-fungible token in a wallet associated with the system.

18. The system of claim 17, wherein the operations further comprise:
transferring the non-fungible token from the wallet associated with the system to a second wallet associated with the winning user.

19. The system of claim 18, wherein the operations further comprise:
writing a transfer of the non-fungible token from the wallet associated with the system to the second wallet associated with the winning user to the blockchain.

20. The system of claim 15, wherein the operations further comprise:
generating an artificial intelligence driven prediction based on the data; and
causing presentation of the artificial intelligence driven prediction in the portal.
